(19) United States
(12) Patent Application Publication
(10) Pub. No.: US 2009/0165771 A1
(43) Pub. Date: Jul. 2, 2009

(54) FOLDABLE AND REMOVABLE SIDE TABLE FOR BBQ GRILL

(75) Inventor: Michael W. Selk, Rockaway, NJ (US)

Correspondence Address: LUCAS & MERCANTI, LLP, 475 PARK AVENUE SOUTH, 15TH FLOOR, NEW YORK, NY, 10016, US

(73) Assignee: GEOGLOBAL PARTNERS, LLC, South Plainfield, NJ (US)

(21) Appl. No.: 11/964,902

(22) Filed: Dec. 27, 2007

(51) Int. Cl. A47J 37/07; B62B 3/02; A47B 37/00; A47B 3/00

(52) U.S. Cl. 126/25 R; 280/35; 108/44; 108/134

(57) ABSTRACT

Cooking apparatus includes a support structure which supports a cooking area, a side attachment such as a side table removably attached to the support structure and extending laterally alongside the cooking area, and connecting assemblies which enables the foldability and removability of the side table. Each connecting assembly includes two pins attached to vertical supports of the support structure and side brackets attached to the side table which each include two substantially L-shaped slots into which the pins are received. The slot of each bracket closest to an elongate portion of the bracket opens to an outer edge and is oriented upward while the other slot of each bracket opens to the inner edge and is also oriented upward.

### FIELD OF THE INVENTION

The present invention relates generally to a side attachment for a portable cooking apparatus and which is both foldable and removable and more particularly to a side table for a BBQ grill which is both foldable and easily removable.

### BACKGROUND OF THE INVENTION

Portable cooking apparatus such as BBQ grills often include a main cooking area and a horizontally oriented attachment attached to a side of the housing which supports the main cooking area. The attachment may be an electric burner, a support platform or table (commonly referred to as a side table) and the like. To enable easy storage and optimized use of the BBQ grill, the attachment is often designed to be foldable into a vertical position in which it is situated alongside the housing and sometimes may even be removable to enable easier transport and storage.

The prior art includes some BBQ grills with foldable and/or removable side tables. For example, U.S. Pat. No. 5,873,355 (Schlosser et al.) shows a foldable and removable side table which pivots about spring wires or pivot pins between a horizontal position and a vertical position. By compressing the spring wires to remove them from their mounting location, the side table is allegedly removable from the support structure which supports the main cooking area.

U.S. Pat. Appln. Publ. No. 2007/0169768 (Chung) shows a foldable side table for a grill, but which is not easily removable. The side table is attached via pivot pins on side brackets to vertical supports of the frame of the grill. Each side bracket includes an arcuate opening and a slot into which a respective pin is placed. A stop bar is provided on each vertical support of the frame of the gill. The side table is movable from a horizontal position, wherein the pivot pins are at an uppermost end of the slots and resting pieces formed by the rear edges of the side brackets rest against the stop bars, to a vertical, folded position wherein the stop bars are received in the arcuate openings.

U.S. Pat. No. 1,903,262 (Goings) describes a removable table for a stove which has hooks which engage the stove and enable the table to be selectively attached to and removed from engagement with the stove. Brackets support the table in a horizontal position.

U.S. Pat. No. 2,541,529 (McAvoy) describes a grill having foldable side trays attached by removable pivots to a frame of the grill. The trays can be pivoted into a downward position by manipulating braces and maintained in the horizontal position by securing the braces.

U.S. Pat. No. 5,906,193 (Leach et al.) describes a grill having a foldable side table with a pair of brackets each having a slot and an opening and cooperating with a pair of pins on the frame of the grill. Pins is fixed in the opening. When the pins are received in the slots, the side table has a horizontal position and when the pins are not in engagement with the slots, the side table has a vertical, folded position.

The foregoing side tables do not provide a simple and easy mechanism to enable a side table or other type of grill attachment to easy move between a horizontal use position and a vertical, non-use position and also to be easily removable from connection with the gill.

### OBJECTS AND SUMMARY OF THE INVENTION

An object of the present invention is to provide a new and improved attachment for a portable cooking apparatus which is both foldable and removable.

It is another object of some embodiments of the present invention to provide a new and improved side table or other type of attachment for a BBQ grill which is both foldable and easily removable.

It is yet another object of some embodiments of the invention to provide a new and improved side table or other type of grill attachment which is designed to easily move between a horizontal use position and a vertical, non-use position and also to be easily removable from connection with the grill.

In order to achieve one or more of these objects and possibly others, a cooking apparatus in accordance with the invention includes a support structure which supports a cooking area of the cooking apparatus, a side attachment such as a side table removably attached to the support structure and extending laterally alongside the cooking area, and connecting assemblies which enable the foldability and removability of the side table. To this end, each connecting assembly includes two pins attached to vertical supports of the support structure and side brackets attached to the side table which each include two substantially L-shaped slots into which the pins are received. The slot of each bracket closest to an elongate portion of the bracket opens to an outer edge and is oriented upward while the other slot of each bracket opens to file inner edge and is also oriented upward.

When the side table is positioned such that the pins are at inner ends of the slots, the side table is securely retained in the horizontal position in which file work surface is defined. Lifting the side table upward allows the side table to be pivoted downward about the lowermost pins and out of engagement with the uppermost pins, since the uppermost pins slide out of the slots. The side table is maintained in engagement with the vertical supports of the cooking apparatus via the lowermost pins, although in a vertical orientation in which the work surface is not defined (the folded position). If it is desired to remove the side table from engagement with the vertical supports of the cooking apparatus, the side table is raised upward (while still in the vertical orientation) causing We lowermost pins to slide out of the slots and then moving the side table forward.

The cooking unit may be a grill and wheels may be attached to the vertical support structure so that the grill is portable and easily movable from one location to another.

Another way to consider the invention is as a cooking apparatus including a cooking unit, a vertical support structure for supporting the cooking unit and which defines first and second opposed faces, a side attachment and connecting assemblies each coupling the side attachment to a respective one of the first and second opposed faces of the vertical support structure. The connecting assemblies enable the side attachment to be movable between a horizontal position in which it extends outward from the cooking unit and a folded vertical position in which it extends alongside the vertical support structure, and also to be removable from engagement with the vertical support structure (from the folded vertical position).

Various vertical support structures are possible in accordance with the invention, including any and all of those currently in use, envisioned and variations thereof. In one common construction, the vertical support structure includes a pair of vertical support members arranged parallel to one another alongside the cooking unit with the opposed faces being defined by sides of vertical support members facing one another, e.g., a front vertical support member along the left or night side of the cooking unit and a rear vertical support member along the same side of the cooking unit.

In one particular embodiment, each connecting assembly includes a bracket connected to the side attachment and first and second pins arranged on a respective one of the first and second opposed faces of the vertical support structure, the first pin being situated above the second pin. The bracket cooperates alternatively with both pins when the side attachment is in the horizontal position, with only the second pin when the side attachment is in the vertical position and with no pins when the side attachment has been removed from engagement with the vertical support structure. Each bracket includes first and second substantially L-shaped slots extending from openings fanned in opposite edges of the bracket. More specifically, the first slot extends from an opening in an outer edge of the bracket and has a horizontal portion adjacent the opening and a vertical portion substantially perpendicular to the horizontal portion and the second slot extends from an opening in an inner edge of the bracket and has a horizontal portion adjacent the opening and a vertical portion substantially perpendicular to the horizontal portion. The vertical portions of the slots extend from the respective horizontal portion in the same direction.

Another embodiment of a cooking apparatus in accordance with the invention includes a plurality of vertical support members, two of which define first and second opposed faces, a cooking unit connected to upper end regions of the vertical support members defining the first and second opposed faces, a side attachment, and connecting assemblies each coupling the side attachment to a respective one of the first and second opposed faces of the vertical support members. The connecting assemblies enable the side attachment to be movable between a horizontal position in which it extends outward from the cooking unit and a folded vertical position in which it extends alongside the vertical support member and to be removable from engagement with the vertical support members. The structure of the connecting assemblies may be as described above.

One of the key benefits of the invention is that it reduces assembly time for the consumer as the table is simply installed without the aide of any tools once the body of the grill is assembled. Another key benefit is allowing for rapid adjustability of the table height or easily adding more tables to the grill by simply continuing down the legs with additional pins in either specific or linear locations. Other and further benefits will be apparent from the description provided herein.

### BRIEF DESCRIPTION OF THE DRAWINGS

The following drawings are illustrative of embodiments of the invention and are not meant to limit the scope of the invention as encompassed by the claims.

FIG. 1 is a perspective view of a grill including a side table in accordance with the invention.

FIG. 2 is a perspective view showing the manner in which the side table in attached to the support structure of the grill when in a horizontal, use position.

FIG. 3 is a front view showing the connecting mechanism in a position in which the side table is attached to the support structure of the grill when in a horizontal, use position.

FIG. 4 is a front view showing the connecting mechanism when the side table is in a transitory position between the horizontal, use position and the vertical, folded position.

FIG. 5 is a front view showing the connecting mechanism when the side table is in the vertical, folded position.

FIG. 6 is a front view showing the connecting mechanism when the side table is in a transitory position between the vertical, folded position and removed from connection with the grill.

FIG. 7 is a front view showing the connecting mechanism when the side table has been removed from connection with the grill.

### DETAILED DESCRIPTION OF PREFERRED EMBODIMENTS

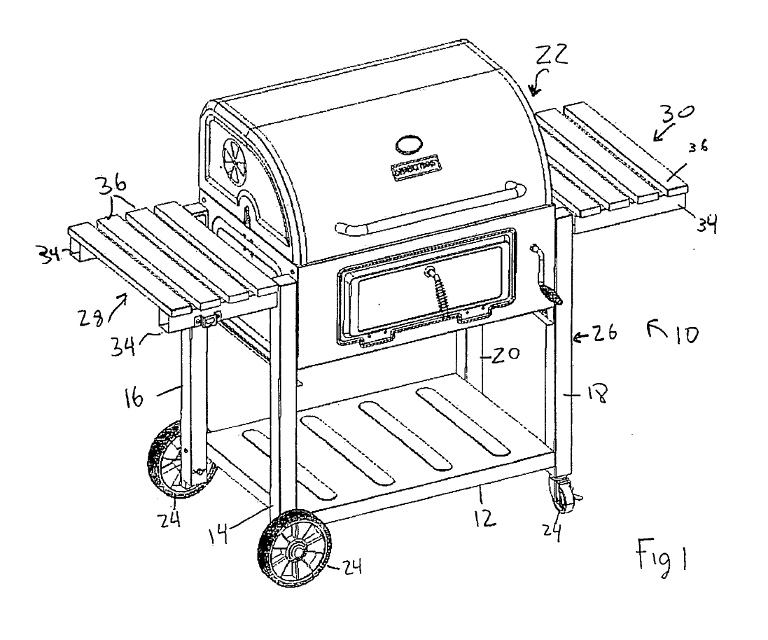

Referring to the accompanying drawings wherein like reference numerals refer to the same or similar elements, FIG. 1 is a perspective view of a grill including a side table in accordance with the invention which is designated generally as 10 and includes a horizontal support member 12, four vertical support members 14, 16, 18, 20 attached to corners of the horizontal support member 12, a cooking unit 22 attached to upper end regions of the vertical support members 14, 16, 18, 20, and wheels 24 attached to lower end regions of the vertical support members 14, 16, 18, 20. The construction of grill 10 may vary from that shown in FIG. 1 and in fact may be significantly different. The actual construction of the grill 10 is not substantially pertinent to the novelty of the invention since the primary novelty of the invention lies in the manner in which attachments are attached to the vertical support members 14, 16, 18, 20.

Thus, alternative constructions of grills may be considered as the invention, including those without a horizontal support member 12, those with more than one horizontal support member, those without wheels 24, those with wheels on fewer than all of the vertical support members, those with different cooking units than that shown in FIG. 1, those with more than one cooking unit, those with more or less than four vertical support members 14, 16, 18, 20, those in which the cooking unit 22 is not attached to the upper end regions of the vertical support members 14, 16, 18, 20 and those in which the vertical support members are not attached to corners of the horizontal support member.

Further, FIG. 1 shows the vertical support members 14, 16, 18, 20 being substantially straight and upright. This is also not required for a grill in accordance with the invention, and curved vertical support members are also envisioned. The primary condition of the vertical support members is that two faces are provided opposing one another to thereby enable an attachment to be attached with a respective side of the attachment being coupled to each face. Accordingly, in a common form, a grill in accordance with the invention would include two vertical support members each of which has a portion facing the other and an attachment is connected to these support: members at the facing portions. It is envisioned however that a grill might be constructed with a single vertical support member which provides both opposing faces. As such, any type and construction of a support structure for a cooking unit which defines two opposing faces is usable in accordance with the invention. Hereinafter, the vertical support members 14, 16, 18, 20 will collectively be referred to as the vertical support structure 26.

Grill 10 includes two side tables 28, 30 with side table 28 being attached to vertical support members 14, 16 and side table 30 being attached to vertical support members 18, 20. In accordance with the invention, side table 28 is attached to vertical support members 14, 16 and/or side table 30 is attached to vertical support members 18, 20 using unique connecting assemblies 32. Thus, if side table 28 is attached to vertical support members 14, 16 using connecting assemblies 32, then side table 30 may also be attached to vertical support members 18, 20 using the same connecting assemblies 30, or may be fixed to the vertical support members 18, 20 (i.e., not removable or foldable relative thereto), or may be attached to the vertical Support members 18, 20 using a different type of connecting assemblies (one which might provide side table 30 with the ability to be foldable relative to the vertical support members 18, 20 or with the ability to be removable relative to the vertical support members 18, 20 or both foldable and removable relative to the vertical support members 18, 20 but in a different manner than with connecting assemblies 32). The same alternatives would be available for side table 28 if side table 30 were attached to the vertical support members 18, 20 using connecting assemblies 32. Thus, a grill in accordance with the invention contemplates only a single side attachment such as a side table which is attached to opposing faces of a vertical support structure using connecting assemblies 32 in accordance with the invention, described below.

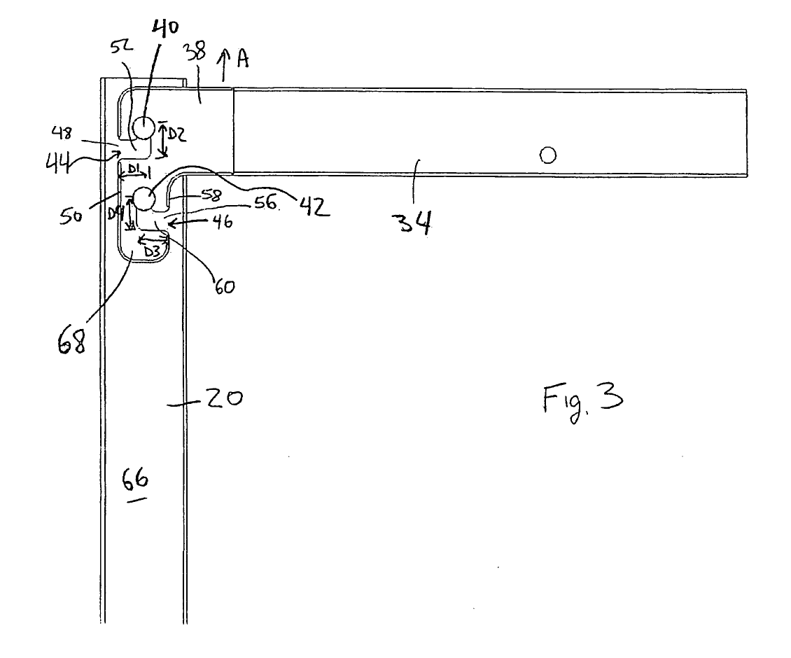

Side tables 28, 30 are shown having a pair of support beams 34, one on each side of the side table, i.e., a front of the side table 28, 30 which is proximate the front of the cooking unit 22 and a rear of the side table 28, 30 which is proximate the rear of the cooling unit 22. Slats 36 are mounted to the support beams 34, but are not shown in FIGS. 3-7. Typically, the front of the cooking unit 22 is considered that part which is opened to access the interior of the cooking unit 22 or that part having the manual controls which enable control of the cooking unit 22.

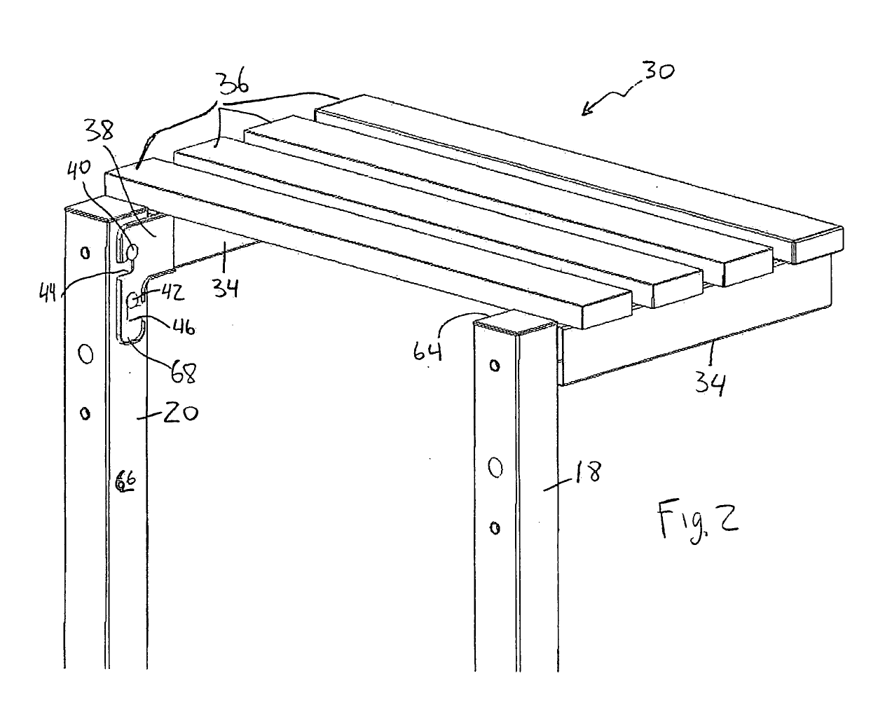

Connecting assembly 32 includes a bracket 38 attached to or formed integral with each support beam 34 and two pins 40, 42 attached to the opposed faces of the vertical support structure 26 to which each side table 28, 30 will be coupled (see FIG. 2). For simplicity sake, the description of the connecting assembly 32 will be made with reference to side table 30, although the same connecting assembly 32 may be used for side table 28 as mentioned above.

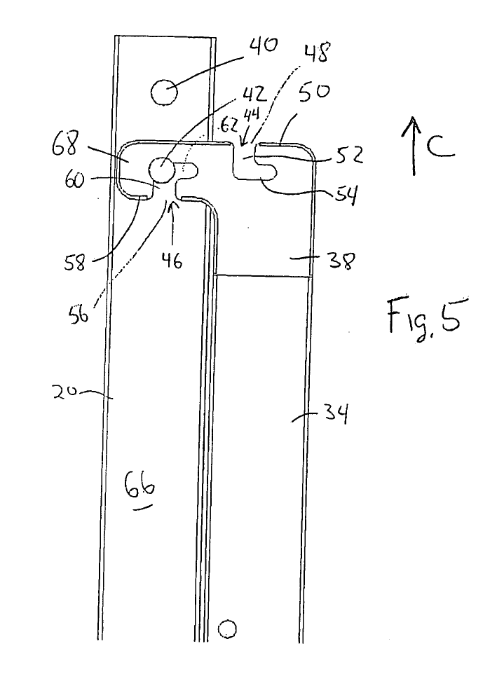

The brackets 38 have a specific construction to enable the connecting assembly 32 to enable the side table 30 to be both easily foldable from the horizontal position shown in FIG. 1, in which the horizontal platform defined by the side table 30 can be used, to a vertical position, shown in FIG. 5. In the vertical position, the side table 30 remains attached to the grill 10, i.e., to the vertical support structure 26, and thus when the grill 10 is moved, the side table 30 is moved along with the grill 10. When it is desired to use side table 30 to support objects at the new location, the side table 30 can easily be moved into the horizontal position shown in FIG. 1.

Specifically, each bracket 38 includes two substantially L-shaped slots 44, 46 having a particular construction. Slot 44 extends from an opening 48 in the outer edge 50 of the bracket 38 a distance D1 and then extends upward a distance D2, forming an approximate right angle between a horizontal portion 52 of the slot 44 and a vertical portion 54 of the slot 42. Slot 46 extends from an opening 56 in the inner edge 58 of the bracket 38 a distance D3 and then extends upward a distance D4, forming an approximate right angle between a horizontal portion 60 of the slot 46 and a vertical portion 62 of the slot 46. Thus, vertical portion 62 of slot 46 extends from horizontal portion 60 in the same direction as vertical portion 54 extends from horizontal portion 52 of the slot 44.

Proper selection of dimensions D1, D2, D3 and D4 is important to facilitate easy engagement of the side table 30 with the vertical support structure 96 and disengagement of the side table 30 therefrom. For example, when pins 40, 42 define a vertical axis therebetween, distances D1 and D3 are selected to enable vertical portions 54, 62 to align with one another, i.e. be oriented in the same direction and/or share a common axis. Determination of dimensions D2 and D4 is important to allow the pins 40, 42 to rest against the upper edge of the respective vertical portion 54, 62 simultaneously and also to align with the respective horizontal portion 52, 60 simultaneously.

The pins 40, 42 are mounted on the vertical support structure 26 at a set distance apart and such that pin 40 on one of the opposing faces of the vertical support structure 26 is at the same vertical level as pin 40 on the other opposing face of the vertical support structure 26 and such that pin 42 on one of the opposing faces of the vertical support structure 26 is at the same vertical level as pin 42 on the other opposing face of the vertical support structure 26. A deviation in the vertical level of the pins 40, 42 will cause the side table 30 to be slanted and deviate from the exact horizontal plane. Moreover, if the distance between the pins 40, 42 on each opposing face of the vertical support structure 26 is not the same, then the side table 30 will not easily be engaged with and disengaged from the vertical support structure 26. The distance between the pins 40, 42 is substantially equal to the distance between the openings 48, 56 in the inner and outer edges 50, 58 of the brackets 38.

Pins 40, 42 may be fixed to the vertical support structure e.g., welded to the vertical support member 18 on a face 64 which opposes a face 66 of the vertical support member 20 (see FIG. 2). Pins 40, 42 may also be screwed into the vertical support members 18, 20 or nailed therein. Pins 40, 42 may be any form of projection formed on the opposing faces of the vertical support structure 26 to which the side table 30 is to be attached.

Referring now to FIGS. 3-7, the manner in which the side table 30 is foldable and removable from engagement with the grill 10 will now be described. FIG. 3 shows the side table 30 in the horizontal, use position (without slats 36). In this position, pin 40 is situated in the vertical portion 54 preferably in contact with the upper edge of the bracket 38 defining die vertical portion 54 while pin 42 is situated in the vertical portion 62 preferably in contact with the upper edge of the bracket 38 defining the vertical portion 62. In this position, side table 30 is secured and can be used to support various objects necessary for use of the grill 10 and cooking unit 22 thereof, e.g., dishes, utensils, condiments, BBQ sauces. Any pressure exerted by the user or these objects does not lead to collapse of the side table in view of the inability of the pins 40, 42 to inadvertently fall out of the slots 44, 46.

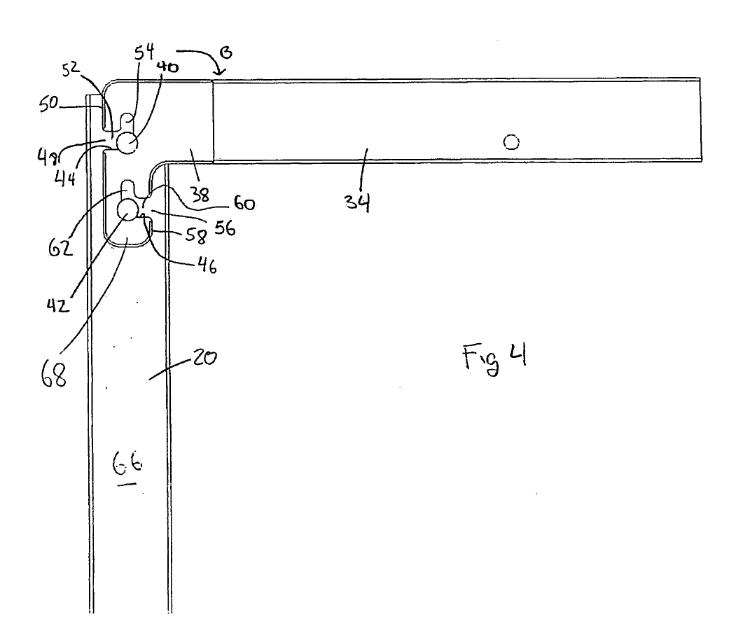

When the user wants to move the side table 30 into the vertical, folded position, or to remove the side table from the grill 10, any objects thereon would first be removed and then the side table 30 would be grasped and lifted slightly upward to the transitory position shown in FIG. 4 (the lifting direction being represented by arrow A in FIG. 3). In this position, the pins 40, 42 are separated from the upper edges of the bracket 38 defining the vertical portions 54, 62, respectively, and brought into alignment with the horizontal portions 52, 60, respectively. Thus, each pin 40, 42 is at a corner defined by the respective horizontal and vertical portions 52, 54, 60, 62.

Then, the side table 30 is pivoted about the pin 40 (in the direction of arrow B in FIG. 4), without pin 42 leaving the slot 46, and brought into the position shown in FIG. 5. During this pivoting movement, pin 40 is removed from slot 44 through the horizontal portion 52. Pin 42 remains at the corner defined by the horizontal and vertical portions 60, 62. As such, the side table 30 has now been brought into a folded position in which it lies adjacent and alongside the vertical support structure 26, i.e., the vertical support members 18, 20.

It is important to note that side table 30 is still in engagement with the vertical support structure 26 so that at a moment's notice, if it is desired to use the side table 30, the user can easily pivot the side table 30 about pin 42, causing pin 40 to be received in slot 44 and then once pin 40 aligns with vertical portion 54 (i.e., is at the corner defined by the horizontal and vertical portions 52, 54), the user would lower the side table 30 until pins 42, 44 contact the upper edges of the bracket 38 defining the vertical portion 54, 62, respectively. The connecting assembly 30 therefore provides an easy manner for folding and unfolding the side table 30 from the grill 30. This is particularly useful since sometimes, the side table 30 may not be needed and can be folded or the grill 10 may be moved and it is desired to provide the grill 10 with the smallest profile.

From the folded position shown in FIG. 5, it may be desired to remove the side table 30 from complete engagement with the grill 10. This may be desired for transport or storage purposes or to make cleaning the side table 30 or grill 10 easier.

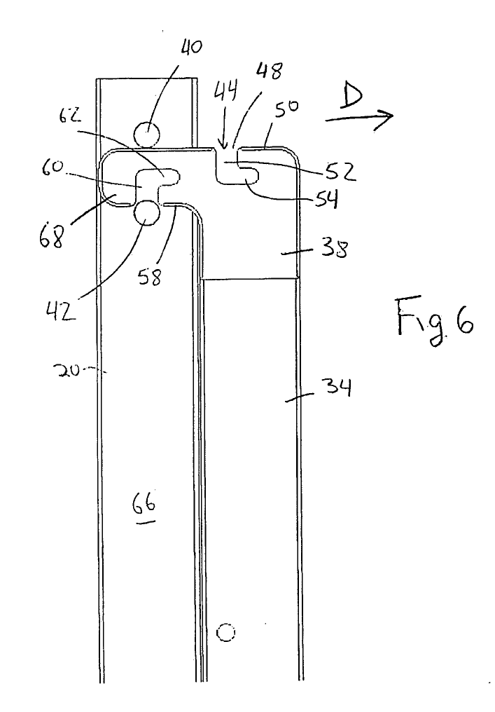

To this end, the user would lift the side table 30 (when in the vertical orientation) in the direction of arrow C in FIG. 5 until the pin 42 is completely removed from the slot 46, i.e., has been withdrawn from the horizontal portion 60, and the side table 30 is in the position shown in FIG. 6. The pin 42: must be sufficiently removed from the slot 46 to enable a tail portion 68 of the bracket 38 to pass between the pins 40, 42 (note that the head of the pin 42 may be larger than a shaft of the pin 42 so that even though it does not appear that the tail portion 68 can fit between the pins 40, 42—since the heads of the pins 40, 42 are shown—the tail portion 68 will fit between the shafts of the pins 40, 42). During this movement, the outer edge 50 of the bracket 38 approaches and may come into contact with the pin 40 as shown in FIG. 6.

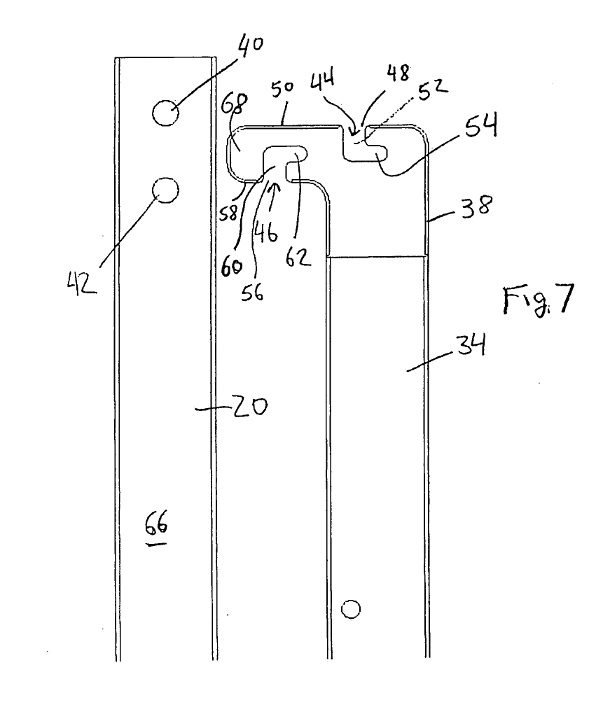

Thereafter, the user moves the side table 30 in the direction of arrow D causing tail portion 68 to be removed from its adjacency to the vertical support structure 26, and the side table 30 is thereby completely removed from engagement with the vertical support structure 26 and thus the grill 10 (see FIG. 7). The side table 30 can thus be stored apart from the grill 10 and the grill 10, moved or stored without the side table 30. In addition, the side table 30 can be cleaned if needed.

Once the side table 30 has been removed from engagement with the grill 30, another side table or another type of side attachment can be coupled to the vertical support structure 26 of the grill 10, provided it has a pair of brackets 38 spaced apart from one another the same distance as brackets 38 are spaced apart from one another on side table 30. Thus, in a grill assembly, it is possible to provide a plurality of side attachments having different constructions, e.g., a side table which provides a planar support surface, a side cooking surface such as an electric or gas burner, a side cooling surface, and the like. Such attachments could be used interchangeably and easily inserted and removed from engagement with the vertical support structure 26 of the grill 10 in accordance with the whims and needs of the user.

To reattach the side table 30 to the vertical support structure, the side table 30 is grasped and the tail portions 68 of the brackets 38 are inserted between the pins 40, 42 until the pin 42 aligns with the horizontal portion 60 of slot 46 (die position shown in FIG. 6). The side table 30 is then lowered causing the pin 42 to enter into slot 46, i.e., pass through the horizontal portion 60 thereof. At this point, the side table 30 is as shown in FIG. 5 and is in the folded position. If it is then desired to move the side table 30 into the horizontal position, the side table 30 is pivoted upward about pin 42 (counterclockwise in FIG. 5), causing pin 40 to be received in slot 44 and then once pin 40 passes through the horizontal portion 52 of slot 44 and aligns with vertical portion 54 of slot 44 (FIG. 4), the side table 30 is lowered until pins 40, 42 contact the upper edges of the bracket 38 defining the vertical portion 54, 62, respectively (FIG. 3). The side table 30 is then in the stable, horizontal position.

The connecting assembly 32 of the brackets 38 and pins 40, 42 therefore provides an innovative system for enabling easy folding and removal of a side table or other side attachment from a BBQ grill or other portable cooking apparatus. Folding and removal of the side table 30 each involves only movement of the side table 30 in a particular manner and does not require, for example, removal of screws or other hardware. That is, by positional movement alone, it is possible to convert the side table from its horizontal position into a vertical, folded position and then from this vertical, folded position, completely remove the side table 30 from engagement with the grill 30. Yet, in spite of facilitating the foldability and removability by virtue of positional movement alone, the side table 30 is still held securely in connection with the grill 30 in both the horizontal, use position and the vertical, folded position. This ability and capability provides a grill 10 including a side table 30 and connecting mechanism 32 for connecting the side table 30 to a vertical support structure 26: of the grill in accordance with the invention with significant advantages over prior art grills with removable and/or foldable side tables.

While particular embodiments of the invention have been shown and described, it will be obvious to those skilled in the art that changes and modifications may be made without departing from the invention in its broader aspects, and, therefore, the aim in the appended claims is to cover all such changes and modifications as fall within true spirit and scope of the invention.

1. A cooking apparatus, comprising:
a cooking unit;
a vertical support structure for supporting said cooking unit, said vertical support structure defining first and second opposed faces;
a side attachment; and
connecting assemblies each coupling said side attachment to a respective one of said first and second opposed faces of said vertical support structure, said connecting assemblies being arranged to enable said, side attachment to be movable between a horizontal position in which it extends outward from said cooking unit and a folded vertical position ins which it extends alongside said vertical support structure and to be removable from engagement with said vertical support structure,
each of said connecting assemblies including a bracket connected to said side attachment and first and second pins arranged on a respective one of said first and second opposed faces of said vertical support structure, said first pin being arranged above said second pin, said bracket being arranged to cooperate alternatively with both of said first and second pins when said side attachment is in the horizontal position, with only said second pin when: said side attachment is in the vertical position and with none of said pins when said side attachment has been removed from engagement with said vertical support structure.

2. The cooking apparatus of claim 1, wherein said vertical support structure includes a pair of vertical support members arranged parallel to one another, said opposed faces being defined by sides of vertical support members facing one another.

3. The cooking apparatus of claim 1, wherein each of said brackets includes first and second substantially L-shaped slots extending from openings formed in opposite edges of said bracket.

4. The cooking apparatus of claim 3, wherein said first slot extends from an opening in an outer edge of said bracket and has a horizontal portion adjacent said opening and a vertical portion substantially perpendicular to said horizontal portion and said second slot extends from an opening in an inner edge of said bracket and has a horizontal portion adjacent said opening and a vertical portion substantially perpendicular to said horizontal portion and which extends from said horizontal portion in the same direction as said vertical portion of said first slot extends from said horizontal portion of said first slot.

5. The cooking apparatus of claim 4, wherein a size of said horizontal and vertical portions of said first and second slots is selected such that said first and second pins rest against upper edges of said first and second slots when said side attachment is in the horizontal position.

6. The cooking apparatus of claim 4, wherein said first and second pins are arranged a distance apart which is substantially equal to a distance between said openings in said inner and outer edges of said bracket.

7. The cooking apparatus of claim 1, wherein said vertical support structure defines third and fourth opposed faces, further comprising:
an additional side attachment; and
additional connecting assemblies each for coupling said additional side attachment to a respective one of said third and fourth opposed faces of said vertical support structure, said connecting assemblies being arranged to enable said additional side attachment to be movable between a horizontal configuration in which it extends outward from said cooking unit and a folded vertical configuration in which it extends alongside said vertical support structure and to be removable from engagement with said vertical support structure.

8. The cooking apparatus of claim 7, wherein said side attachments are side tables which provide a horizontal support surface and extend outward from said cooking unit in opposite directions.

9. The cooking apparatus of claim 1, wherein said cooking unit is a grill, further comprising wheels attached to said vertical support structure to enable movement of the cooking apparatus.

10. The cooking apparatus of claim 1, wherein said side attachment is a side table.

11. A cooking apparatus, comprising:
a plurality of vertical support members, a pair of said vertical support members defining first and second opposed faces;
a cooking unit connected to upper end regions of said vertical support members;
a side attachment; and
connecting assemblies each coupling said side attachment to a respective one of said first and second opposed faces of said vertical support members, said connecting assemblies being arranged to enable said side attachment to be movable between a horizontal position in which it extends outward from said cooking unit and a folded vertical position in which it extends alongside said vertical support member and to be removable from engagement with said vertical support members,
each of said connecting assembles including a bracket connected to said side attachment and first and second pins arranged on a respective one of said first and second opposed faces of said vertical support members, said first pin being arranged above said second pin, said bracket to being arranged to cooperate alternatively with both of said first and second pins when said side attachment is in the horizontal position, with only said second pin when said side attachment is in the vertical position and with none of said pins when said side has been removed from engagement with said vertical support members.

12. The cooking apparatus of claim 11, wherein each of said brackets includes first and second substantially L-shaped slots extending from openings formed in opposite edges of said bracket.

13. The cooking apparatus of claim 12, wherein said first slot extends from an opening in an outer edge of said bracket and has a horizontal portion adjacent said opening and a vertical portion substantially perpendicular to said horizontal portion and said second slot extends from an opening in an inner edge of said bracket and has a horizontal portion adjacent said opening and a vertical portion substantially perpendicular to said horizontal portion and which extends from said horizontal portion in the same direction as said vertical portion of said first slot extends from said horizontal portion of said first slot.

14. The cooking apparatus of claim 13, wherein a size of said horizontal and vertical portions of said first and second slots is selected such that said first and second pins rest against upper edges of said first and second slots when said side attachment is in the horizontal position.

15. The cooking apparatus of claim 13, wherein said first and second pins are arranged a distance apart which is substantially equal to a distance between said openings in said inner and outer edges of said bracket.

16. The cooking apparatus of claim 11, wherein said side attachment is a side table.

17. The cooking apparatus of claim 11, wherein an additional pair of said vertical support members defines third and fourth opposed faces, further comprising:
an additional side attachment; and
additional connecting assemblies for coupling said additional side attachment to said third and fourth opposed faces of said vertical support members, said connecting assemblies being arranged to enable said additional side attachment to be movable between a horizontal configuration in which it extends outward from said cooking unit and a folded vertical configuration in which it extends alongside said vertical support members and to be removable from engagement with said vertical support members.

18. The cooking apparatus of claim 17, wherein said side attachments are side tables which provide a horizontal support surface and extend outward from said cooking unit in opposite directions.

19. The cooking apparatus of claim 11, wherein said cooking unit is a grill, further comprising wheels attached to said vertical support members to enable movement of the cooling apparatus.
